(19) United States
(12) Patent Application Publication
(10) Pub. No.: US 2006/0012059 A1
(43) Pub. Date: Jan. 19, 2006

(54) Method for manufacturing an optical sheet

(76) Inventors: Ya-Chuan Cheng, Ping Chen City (TW); Sheng-Wen Lin, Ping Chen City (TW); Tseng-Cheng Wu, Ping Chen City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/940,082

(22) Filed: Sep. 14, 2004

(30) Foreign Application Priority Data
Jul. 14, 2004 (TW) 93121024

(51) Int. Cl. B29D 11/00

(52) U.S. Cl. 264/1.34; 264/1.38; 264/1.7

(57) ABSTRACT

A resin is spread on a transparent substrate to form a resin layer. The resin layer has a plurality of strip structures, and a viscosity of the resin is between 20 and 1000 cps. Next, the resin layer is cured such that a combination of the transparent substrate and the resin layer becomes an optical sheet.

### BACKGROUND

1. Field of Invention

The present invention relates to an optical sheet for a flat display. More particularly, the present invention relates to a method for manufacturing an optical sheet.

2. Description of Related Art

Liquid crystal display (LCD) has many advantages over other conventional types of displays including high display quality, small volume, light weight, low driving voltage and low power consumption. Hence, LCDs are widely used in small portable televisions, mobile telephones, video recording units, notebook computers, desktop monitors, projector televisions and the like, and have gradually replaced the conventional cathode ray tube (CRT) as a mainstream display unit.

In a flat display, polarizers are main elements for the display panel thereof. In general, a polarizer is made of one or more than one optical sheets; the polarizer therefore has other functions, such as anti-peeping or optical compensation, in addition to the function of polarizing. In order to achieve the functions mentioned above, various additional processes are carried out on the surfaces of the optical sheets, like sputtering, exposure and development, and dry etching.

However, sizes of special structures formed on the surfaces of the optical sheets by the foregoing processes, such as trenches or other patterns, are in the micrometer scale. Therefore, complex and delicate semiconductor techniques are typically applied on these surfaces to form the special and subtle structures. The implication is that complicated and expensive manufacturing devices are used to manufacture these optical sheets with additional functions.

Therefore, the optical sheets manufactured by conventional techniques are expensive and require complex processes, and are difficult to mass produce.

### SUMMARY

The optical sheets manufactured by the conventional techniques generally have some disadvantages, like complex manufacturing processes and high manufacturing cost. The complex manufacturing processes reduce the yields of the optical sheets, and the high manufacturing cost is adverse to product popularization.

It is therefore an objective of the present invention to provide a method for manufacturing an optical sheet, in which strip structures with various functions are directly formed by spreading resin with a suitable viscosity to simplify manufacturing processes and decrease manufacturing costs.

In accordance with the foregoing and other objectives of the present invention, a method for manufacturing an optical sheet is provided. A transparent substrate is provided, and a resin is spread on the transparent substrate to form a resin layer. The resin layer has a plurality of strip structures, and a viscosity of the resin is between 20 and 1000 cps. Next, the resin layer is cured such that a combination of the transparent substrate and the resin layer becomes an optical sheet.

According to preferred embodiments of the present invention, a solid content of resin to solvent in the resin is greater than 40%. The resin layer is cured by UV light. The two sides of the transparent substrate are exposed to UV light of more than 80 Watts to cure the resin layer. The transparent substrate is triacetate cellulose, polyethylene terephthalat, polycarbonate or acrylic. The resin is acrylic resin or epoxy resin.

When the resin is spread, a wire bar can be used to spread the resin on the transparent substrate, and the strip structures are oriented in a single direction. Sizes of the strip structures are controlled by a spreading speed and spacings of the wire bar. Alternatively, a gravure can be used to spread the resin on the transparent substrate, and the strip structures are oriented in at least two directions. Sizes of the strip structures are controlled by a spreading speed and pattern widths of the gravure.

According to several embodiments of the present invention, the optical sheet of the invention can be an optical compensation film, a privacy film or an optical sheet with another function. When the optical sheet is an optical compensation film, the optical compensation film has a retardation value to compensate for light leakage or view-angles of the display. When the optical sheet is a privacy film, the strip structures are oriented in a predetermined direction, and a predetermined thickness of the strip structures limits viewing angles of the privacy film to between 40 and 90 degrees. Moreover, during manufacturing of the privacy film, a dark dye can be mixed into the resin to enhance the anti-peeping effect.

The optical sheet of the present invention is entirely manufactured by the existent and simple processes for manufacturing polarizers. The present invention, of which the manufacturing processes are simple and the manufacturing cost is very low, does not require addition of any additional manufacturing devices for mass production.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1 illustrates a flow chart of one preferred embodiment of the present invention;

FIG. 2 illustrates a schematic view of an optical sheet of the preferred embodiment; and

FIG. 3 illustrates a schematic view of UV light exposure of one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides a method for manufacturing an optical sheet, as a substitution for the conventional techniques the need complex processes and are very expensive.

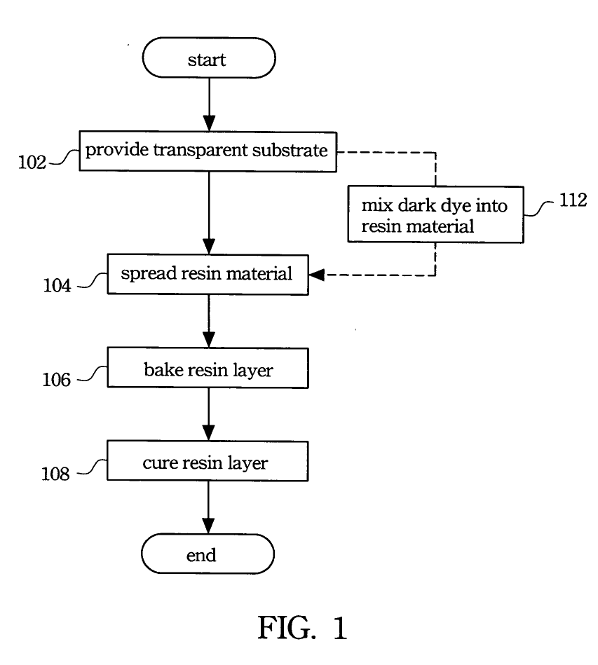

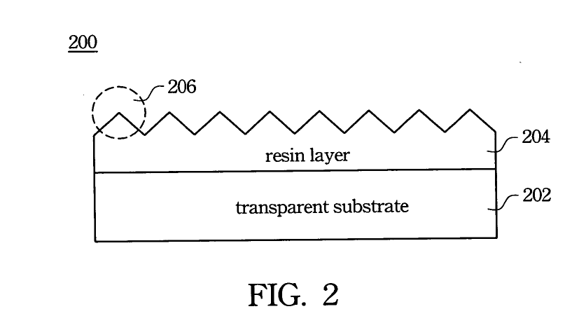

FIG. 1 illustrates a flow chart of one preferred embodiment of the present invention, and FIG. 2 illustrates a schematic view of an optical sheet of the preferred embodiment. The following descriptions are made with reference to FIG. 1 and FIG. 2.

As illustrated in FIG. 2, a transparent substrate 202 is provided (step 102). A material of the transparent substrate 202 is triacetate cellulose, polyethylene terephthalat, polycarbonate or acrylic. A resin is spread on the transparent substrate 202 to form a resin layer 204 (step 104). The resin layer has a plurality of strip structures 206, such as triangular strip structures or semicircular strip structures. Shapes, sizes and positions of the strip structures 206 can be determined by a spreading tool, like spacings of a wire bar or patterns of a gravure.

In the preferred embodiment, the resin is acrylic resin or epoxy resin, and a viscosity of the resin is between 20 and 1000 cps. The suitable viscosity can help the strip structures 206 maintain the shapes and positions thereof formed by spreading, before they are subsequently cured. Moreover, a solid content of resin to solvent in the resin is greater than 40%. When the solid content of resin to solvent in the resin is greater, the sizes of the strip structures 206 can be prevented from shrinking because the solvent thereof is removed during baking.

During spreading the resin, the wire bar can be used to spread the resin when the strip structures 206 are oriented in a single direction. At this time, the positions of the strip structures 206 are determined by the wire bar, and a spreading speed and spacings of the wire bar can be used to control sizes of the strip structures 206. When the strip structures 206 are oriented in at least two directions, the gravure can be used to spread the resin. At this time, the positions and shapes of the strip structures 206 are determined by the patterns of the gravure, and a spreading speed and pattern widths of the gravure can also be used to control the sizes of the strip structures 206. Similarly, other conventional spreading techniques suitable for the present invention also can be used in the present invention, and all of them fall into the scope and fit the spirit of the present invention.

After spreading the resin, the resin layer 204 can optionally be baked to remove the solvent or other volatile components therein (step 106). Next, the resin layer 204 is cured, for example, by exposure to UV light of which the power is greater than 80 Watts, such that a combination of the transparent substrate 202 and the resin layer 204 becomes an optical sheet 200 (step 108).

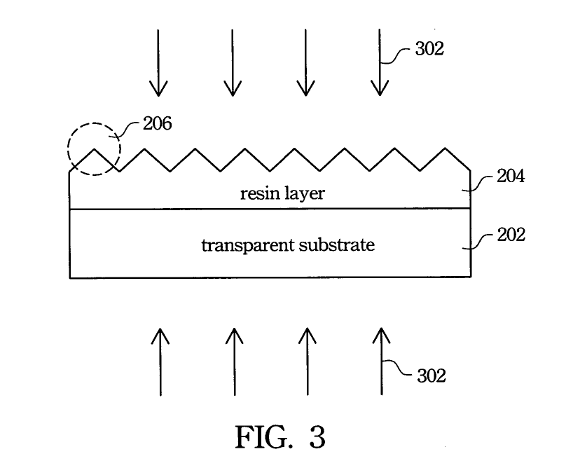

FIG. 3 illustrates a schematic view of UV light exposure of one preferred embodiment of the present invention. As illustrated in FIG. 3, because the resin layer 202 having the strip structures 206 is thicker, UV light shines on the resin layer 202 from two sides of the transparent substrate 202 for mitigating curing incompletion or non-uniformity caused by the thickness. Of course, if the power of UV light is great enough or the transparency of the resin layer 204 for UV light is good, shining UV light from one single direction is sufficient to cure the resin layer 204 in the present invention.

According to another embodiment of the present invention, the resin layer 204 can be cured by an electron-beam. The energy of electron-beam is higher such that the resin layer 204 can be cured by it faster, and therefore the foregoing curing incompletion or non-uniformity can be substantially improved and the processing time is also reduced to raise yields of products. Moreover, the material cured by high energy generally has high resistance, and therefore enhances its abilities to resist chemistry and friction. In addition, under considerations of processing and specification, the resin layer 204 can be cured by UV light and an electron-beam with proper parameters to obtain optimum curing results.

The detailed conditions of the transparent substrate 202 and the strip structures 206 of the optical sheets 200 with various functions may be different because of their functions. The manufacturers can adjust the foregoing processes and parameters according to design and processing needs to get the suitable and optimum optical sheets 200. In other words, in the processes for manufacturing the optical sheet 200, the viscosity and solid content of the resin, the sizes and shapes of the strip structures 206, the baking conditions and other processing parameters can be adjusted to obtain the optical sheet 200 suitable for the needs. Moreover, optical sheets with similar functions may be obtained by different processing parameters. Therefore, the present invention simplifies the manufacturing of optical sheets, and also substantially enhances the adjusting ability of manufacturing processes.

According to several embodiments of the present invention, the optical sheets 200 manufactured by the method of the present invention can be optical compensation films, privacy films or optical sheets with other functions. When the optical sheet 200 is an optical compensation film, the optical compensation film has a retardation value to compensate for light leakage or view-angles of the display. When the optical sheet 200 is a privacy film, the strip structures 206 are oriented in a predetermined direction, and a predetermined thickness of the strip structures 206 limits a range of viewing angles of the privacy film to between 40 and 90 degrees. Moreover, during manufacturing of the privacy film, a dark dye can be mixed into the resin (step 112) to enhance the effect of anti-peeping, as illustrated in FIG. 1.

Furthermore, the optical sheet 200 can be configured adjacent to the backlight source of the flat display to serve as a diffuser or a condenser, according to the shapes of the strip structures 206 and their positions relative to the backlight source. The strip structures 206 have features of anti-sticking, anti-slipping and high mechanical strength, and therefore can be configured on any place inside the flat display to achieve the functions of anti-sticking, anti-slipping and supporting.

The optical sheet of the present invention is entirely manufactured by existent and simple processes for manufacturing polarizers. The present invention, of which the manufacturing processes are simple and the manufacturing cost is very low, does not require addition of any additional manufacturing devices for mass production.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for manufacturing an optical sheet, comprising:
providing a transparent substrate;
spreading a resin on the transparent substrate to form a resin layer, wherein the resin layer includes a plurality of strip structures, and a viscosity of the resin is between about 20 and 1000 cps; and
curing the resin layer such that a combination of the transparent substrate and the resin layer becomes an optical sheet.

2. The method of claim 1, wherein when the optical sheet is a privacy film, the strip structures are oriented in a predetermined direction, and a predetermined thickness of the strip structures makes a range of viewing angles of the privacy film about 40 to 90 degrees.

3. The method of claim 2, wherein the method further comprises mixing a dark dye into the resin.

4. The method of claim 1, wherein when the optical sheet is an optical compensation film, the optical compensation film has a retardation value.

5. The method of claim 1, wherein a solid content of resin to solvent in the resin is greater than 40%.

6. The method of claim 1, wherein the method cures the resin layer with an electron beam.

7. The method of claim 1, wherein the method cures the resin layer with UV light.

8. The method of claim 7, wherein the method exposes two sides of the transparent substrate to UV light to cure the resin layer.

9. The method of claim 7, wherein a power of UV light is greater than about 80 Watts.

10. The method of claim 1, wherein the method spreads the resin on the transparent substrate with a wire bar.

11. The method of claim 10, wherein the strip structures are oriented in a single direction.

12. The method of claim 10, wherein the method further comprises controlling sizes of the strip structures by a spreading speed and spacings of the wire bar.

13. The method of claim 1, wherein the method spreads the resin on the transparent substrate with a gravure.

14. The method of claim 13, wherein the strip structures are oriented in at least two directions.

15. The method of claim 13, wherein the method further comprises controlling sizes of the strip structures by a spreading speed and pattern widths of the gravure.

16. The method of claim 1, wherein a material of the transparent substrate is selected from a group consisting of triacetate cellulose, polyethylene terephthalat, polycarbonate and acrylic.

17. The method of claim 1, wherein the resin is selected from a group consisting of acrylic resin and epoxy resin.
